(19) United States
(12) Patent Application Publication
(10) Pub. No.: US 2024/0393453 A1
(43) Pub. Date: Nov. 28, 2024

(54) Miniature radar array mapping system and method in complex narrow space

(71) Applicant: XI'AN JIAOTONG UNIVERSITY, Xi'an (CN)

(72) Inventors: Yongqi Liang, Xi'an (CN); Xuezhen Zhao, Xi'an (CN)

(21) Appl. No.: 18/793,834

(22) Filed: Aug. 4, 2024

(30) Foreign Application Priority Data
Aug. 4, 2023 (CN) 2023109786911

(51) Int. Cl. G01S 13/89; G05D 1/242

(52) U.S. Cl. CPC G01S 13/89; G05D 1/242

(57) ABSTRACT

A miniature radar array mapping system in complex narrow space includes a miniature radar mapping array, a miniature radar data acquisition module, a host computer and a robot platform. A software system of the host computer includes navigation software and mapping software. The environmental sample data sampled by the miniature radar data acquisition module are transmitted to the navigation software of the host computer. Position, velocity and attitude information of a robot at a current moment are obtained by the navigation software and are transmitted to the mapping software. A 360° 3D mapping model of environment is constructed by the mapping software based on a miniature radar detection model and a miniature radar array model, which is a component unit for generating panoramic 3D maps of the complex narrow space.

### CROSS REFERENCE OF RELATED APPLICATION

The present invention claims priority under 35 U.S.C. 119 (a-d) to CN 202310978691.1, filed Aug. 4, 2023.

### BACKGROUND OF THE PRESENT INVENTION

### Field of Invention

The present invention relates to the field of survey, navigation and control technology, and more particularly to a miniature radar array mapping system and method in complex narrow space.

### Description of Related Arts

In the dark environment, traditional topographic survey methods such as cameras are difficult to play a role. In recent years, light detection and ranging (LiDAR) simultaneous localization and mapping (LiDAR SLAM) technology has attracted the attention of the industry for the detection of dark environments. The current LiDAR SLAM technology uses multi-line lidar for environmental survey, but the multi-line lidar is large in volume and heavy in weight. At the same time, the multi-line lidar has a large amount of environmental sampling data, which requires high computing power for the computer installed on the robot, and is often impossible to achieve high-frequency sampling. Therefore, it is difficult to be applied to micro robots.

### SUMMARY OF THE PRESENT INVENTION

In order to solve the problem that it is difficult for micro robots to realize high-frequency 360° mapping in the dark and lightless environment, the present invention provides a miniature radar array mapping system and a miniature radar array mapping method in complex narrow space, which aims at performing 360° mapping in the dark and lightless indoor environment based on the miniature radar mapping array on the micro robot platform, so as to realize that the micro robots are able to carry out mapping and surveying in a complex and variable terrain environment.

To achieve the above object, the present invention provides technical solutions as follows.

A miniature radar array mapping system in complex narrow space comprises a miniature radar mapping array, a miniature radar data acquisition module, a host computer and a robot platform, wherein:
a software system of the host computer comprises navigation software and mapping software;
the robot platform is an air robot motion platform, a ground mobile robot motion platform, a land and air amphibious robot or underwater robot motion platform;
miniature radars of the miniature radar mapping array are laser radars, ultrasonic radars, millimeter wave radars or a combination of laser radars, ultrasonic radars and millimeter wave radars; and moreover, for underwater environments, active sonar probes are selected to form the miniature radar mapping array; environmental sample data are obtained by environmental information sampling of the miniature radar mapping array and then transmitted to the miniature radar data acquisition module;
the environmental sample data sampled by the miniature radar data acquisition module are transmitted to the navigation software of the host computer;
position, velocity and attitude information of a robot at a current moment are obtained by the navigation software and are transmitted to the mapping software;
a 360° 3D mapping model of environment is constructed by the mapping software based on a miniature radar detection model and a miniature radar array model, which is a component unit for generating panoramic 3D maps of the complex narrow space.

The miniature radar mapping array is installed on the robot platform, and the miniature radars detect the environmental sample information in a direction away from the robot; there are multiple rows of miniature radars in each direction; the miniature radar mapping array is rectangular, H-shaped, polygonal, or circular; or equivalent deformations of these forms, namely, the forward, backward, upward and downward parallel movement of the miniature radars in these arrays; or a combination of these arrays, namely, elliptic, a combination of a portion of rectangle and a portion of circle or arch, a circular or arc-shaped array formed by a portion of a circle or arch; the miniature radar mapping array comprises n miniature radars which are positioned to a body frame OXYZ of the robot, an installation angle of the miniature radars of the miniature radar mapping array comprises an elevation angle β and an azimuthal angle γ in the body frame OXYZ, wherein the elevation angle β is an angle between the orientation of the miniature radars and the XOY plane in the body frame, the azimuthal angle γ is the angle between the orientation of the miniature radars and the YOZ plane in the body frame.

The miniature radars of the miniature radar mapping array are configured to measure surrounding environmental information, and to synchronously or sequentially sample relative distance information between the robot and buildings, walls and objects in surrounding environment according to a preset frequency; the host computer is configured to obtain the environmental sample data of the miniature radars.

The miniature radar detection model is based on two parameters of the miniature radars, namely, a field angle α and a measuring distance d; beam of the miniature radars form a projection surface on a measured object, a shape of the projection surface is affected by a shape of the object, a coverage area of the beam is a circle with a radius of d tan(α/2), here, the measuring distance d is a distance from the object to a miniature radar antenna in the coverage area;

in the miniature radar array model, coordinates of the i^{th} miniature radar in the body frame are

$$[ \begin{matrix}{x}_{b , i}^{r} \\ {y}_{b , i}^{r} \\ {z}_{b , i}^{r}\end{matrix} ] ,$$

setting angles are (βᵢ,γᵢ), i∈{1, 2 . . . , n}, here, the subscript b indicates that in the body frame, the superscript γ indicates that the coordinate value is the coordinate of the i^{th} miniature radar, di is the distance, coordinates of a center point of a area measured by the i^{th} miniature radar indicate measured environmental information and are expressed as

$$[ \begin{matrix}{x}_{b , i} \\ {y}_{b , i} \\ {z}_{b , i}\end{matrix} ] = [ \begin{matrix}{x}_{b , i}^{r} \\ {y}_{b , i}^{r} \\ {z}_{b , i}^{r}\end{matrix} ] + {d}_{i} \cdot [ \begin{matrix}sin {β}_{i} cos {γ}_{i} \\ sin {β}_{i} sin {γ}_{i} \\ cos {β}_{i}\end{matrix} ] ;$$

coordinates

$$[ \begin{matrix}{X}_{b}^{r} \\ {Y}_{b}^{r} \\ {Z}_{b}^{r}\end{matrix} ]$$

of all miniature radars in the body frame are

$$[ \begin{matrix}{X}_{b}^{r} \\ {Y}_{b}^{r} \\ {Z}_{b}^{r}\end{matrix} ] = [ \begin{matrix}{x}_{b , 1}^{r} & {x}_{b , 2}^{r} & … & {x}_{b , n}^{r} \\ {y}_{b , 1}^{r} & {y}_{b , 2}^{r} & … & {y}_{b , n}^{r} \\ {z}_{b , 1}^{r} & {z}_{b , 2}^{r} & … & {z}_{b , n}^{r}\end{matrix} ] ;$$

under a same sampling period, the environmental sample information obtained by environmental information sampling of the miniature radar mapping array is expressed as

$${Z}_{r} = [ \begin{matrix}{d}_{1} & 0 & … & 0 \\ 0 & {d}_{2} & … & 0 \\ ⋮ & ⋮ & ⋱ & ⋮ \\ 0 & 0 & … & {d}_{12}\end{matrix} ] ;$$

a measured value Z_{b} of environmental information sampling of the miniature radar mapping array in the body frame is expressed as

$${Z}_{b} = [ \begin{matrix}{X}_{b}^{r} \\ {Y}_{b}^{r} \\ {Z}_{b}^{r}\end{matrix} ] + A \cdot {Z}_{r} ,$$

here, A is a transformational matrix for transforming the environmental sample information in the body frame, and is expressed as

$$A = [ \begin{matrix}sin {β}_{1} cos {γ}_{1} & sin {β}_{2} cos {γ}_{2} & … & sin {β}_{n} cos {γ}_{n} \\ sin {β}_{1} sin {γ}_{1} & sin {β}_{2} sin {γ}_{2} & … & sin {β}_{n} sin {γ}_{n} \\ cos {β}_{1} & cos {β}_{2} & … & cos {β}_{n}\end{matrix} ] .$$

A miniature radar array mapping method in complex narrow space comprises:
transforming the environmental sample information obtained by the miniature radar mapping array into a ground coordinate system determined at an initial moment, wherein it is required to perform coordinate transformation according to the attitude of the robot, a coordinate transformation matrix C is expressed as

$$C = [ \begin{matrix}cos ψ cos ϕ & cos ψ sin θ sin ϕ - sin ψ cos ϕ & cos ψ sin θ cos ϕ + sin ψ sin ϕ \\ sin ψ cos θ & sin ψ sin θ sin ϕ - cos ψ cos ϕ & sin ψ sin θ cos ϕ - cos ψ sin ϕ \\ - sin ϕ & cos θ sin ϕ & cos θ cos ϕ\end{matrix} ] ,$$

here, ψ is a yaw angle, θ is a pitch angle, ϕ is a roll angle; in order to rotate the coordinate matrix in the body frame to be parallel to the ground coordinate system, the measured value Z_{b} needs to be multiplied by the coordinate transformation matrix C to the left;
coordinates S of a centroid of the robot in the ground coordinate system is obtained by the navigation software, and is expressed as

$$S = [ \begin{matrix}{x}_{e} \\ {y}_{e} \\ {z}_{e}\end{matrix} ] ;$$

based on a superposition of the measured value Z_{b} of the miniature radar mapping array in the body frame and the coordinates

$$[ \begin{matrix}{x}_{e} \\ {y}_{e} \\ {z}_{e}\end{matrix} ]$$

of the centroid of the robot in the ground coordinate system in the same period, coordinates of the environmental sample information of the miniature radar mapping array in the ground coordinate system at this moment are obtained, which are expressed as

$${Z}_{e} = [ \begin{matrix}{x}_{e} \\ {y}_{e} \\ {z}_{e}\end{matrix} ] \cdot I + C \cdot {Z}_{b} ,$$

$$here , I = [ \begin{matrix}1 & 1 & … & 1\end{matrix} ] ;$$

the measured values of the environmental sampling are transformed to the ground coordinate system, and the grids occupied in the three-dimensional space are marked to form a three-dimensional topographic map.

Compared with the prior art, the present invention has some advantages as follows.

In the present invention, the miniature radar mapping array is used to perform the parallel sampling on the surrounding environment information, the sample data are small, the calculation speed is fast, and the sample frequency is high. The mapping system is able to be run on the robot's front-end computer, so that it is able to be applied to the micro robots, and the micro robots are able to be used to survey in the dark and narrow tunnel environment, thus the surrounding environment information is reflected well. While the integrity and the clarity of the mapping are able to be guaranteed, the shortcomings of traditional technology such as large amount of data and high requirement of computing power are avoided, and the real-time mapping is realized in the front end to ensure the real-time performance of the entire robot system.

### BRIEF DESCRIPTION OF THE DRAWINGS

FIG. 1 is a block diagram of a miniature radar array mapping system in complex narrow space.

FIG. 2 is a schematic diagram of a rectangular miniature radar mapping array.

FIG. 3 is a schematic diagram of a staggered rectangular miniature radar mapping array.

FIG. 4 is a schematic diagram of a polygonal miniature radar mapping array.

FIG. 5 is a schematic diagram of an H-shaped rectangular miniature radar mapping array.

FIG. 6 is a schematic diagram of a circular miniature radar mapping array.

FIG. 7 is a schematic diagram of a combined rectangular and circular miniature radar mapping array.

FIG. 8 is a 360° three-dimensional terrain panorama map provided by the present invention.

FIG. 9 is a 360° three-dimensional terrain perspective map provided by the present invention.

### DETAILED DESCRIPTION OF THE PREFERRED EMBODIMENT

The present invention is further described in detail in combination with the attached drawings and specific embodiments.

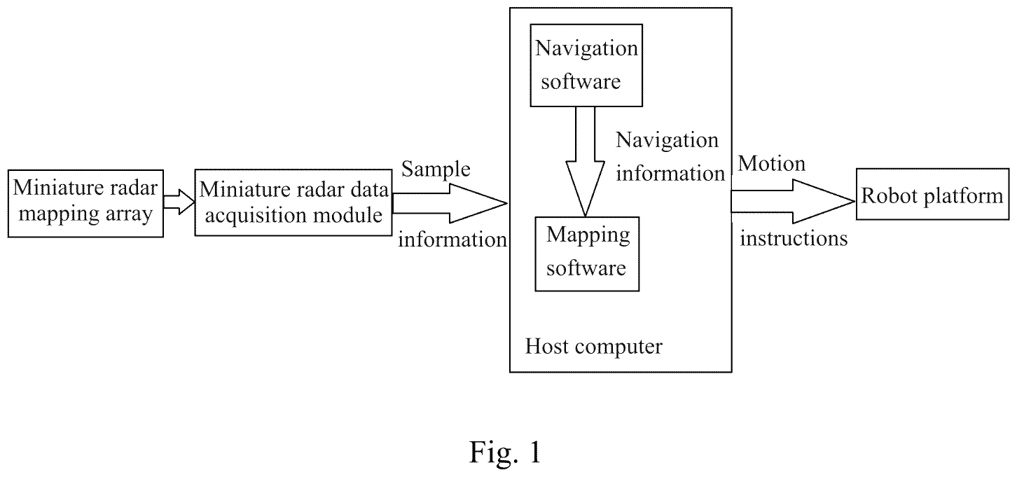

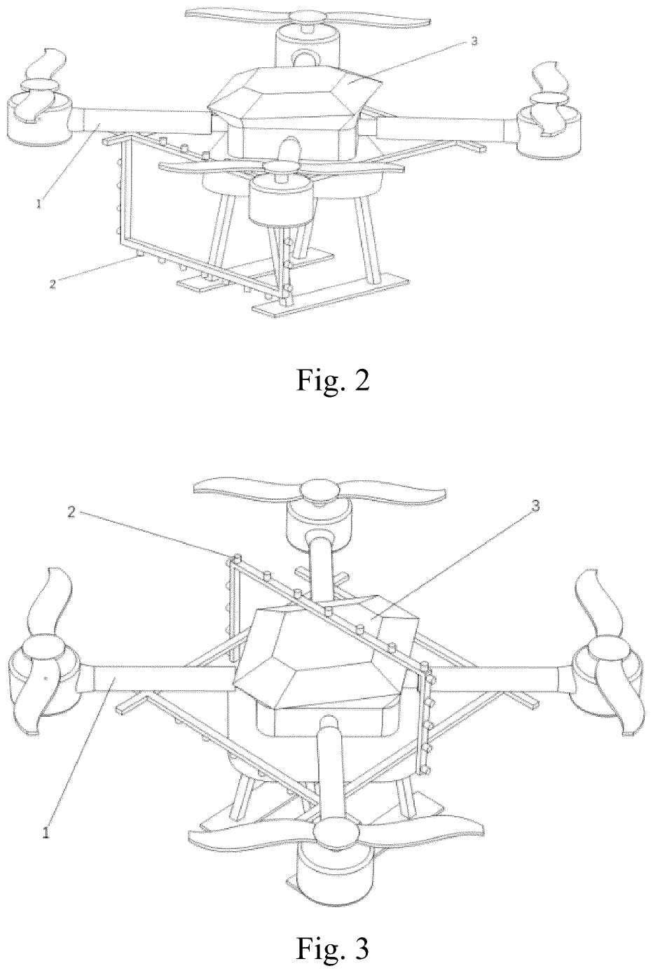

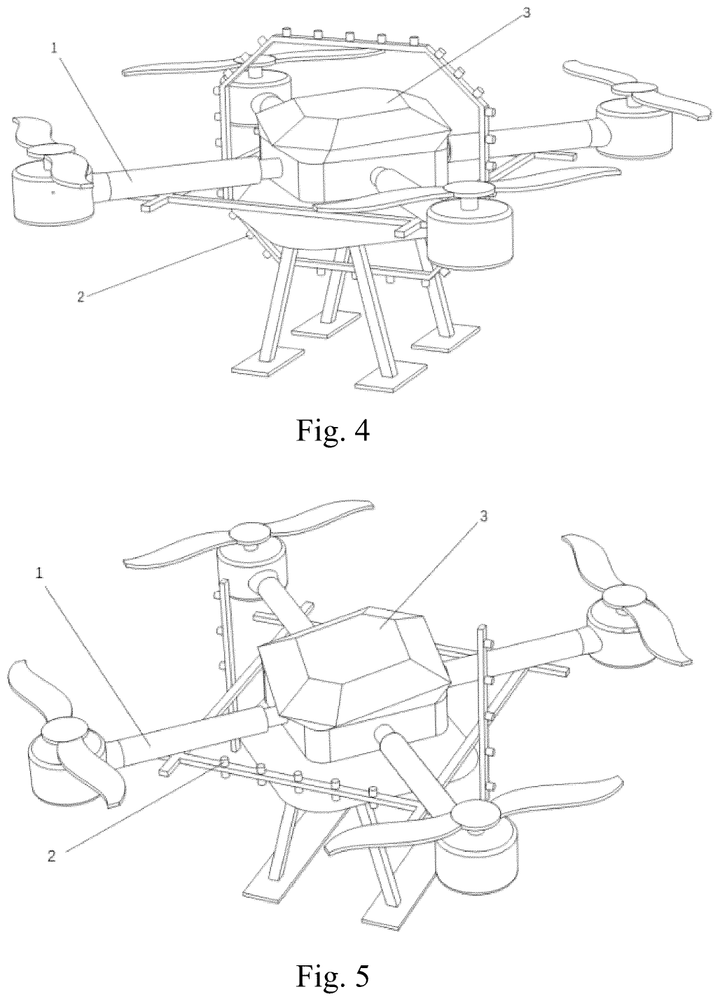

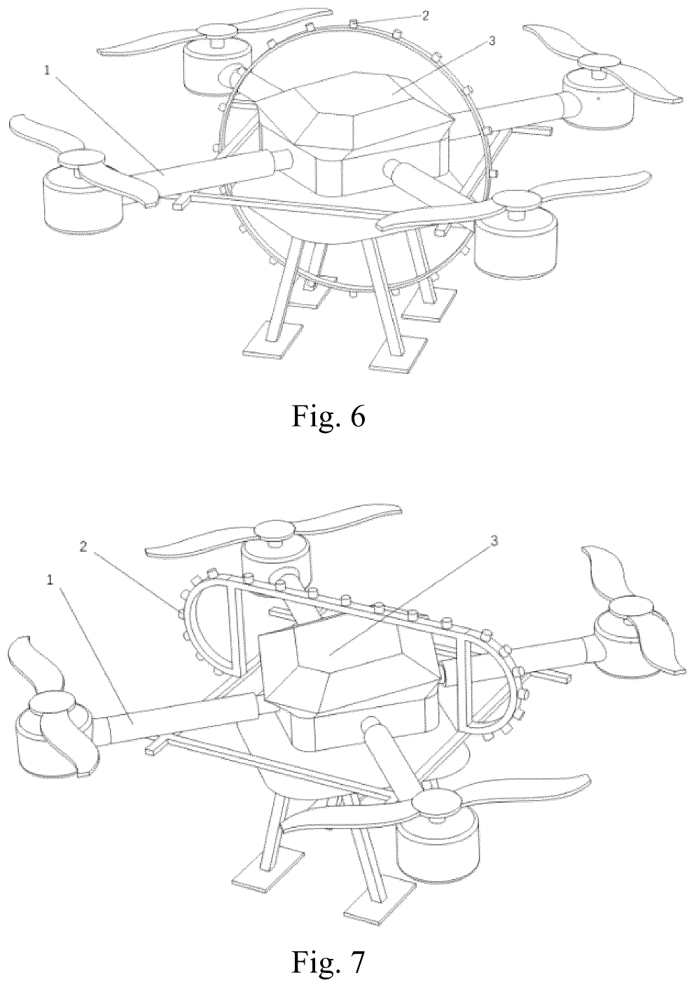

FIG. 1 shows a miniature radar array mapping system in complex narrow space, which comprises a miniature radar mapping array, a miniature radar data acquisition module, a host computer and a robot platform, wherein environmental sample data are obtained by environmental information sampling of the miniature radar mapping array and then transmitted to the miniature radar data acquisition module; the miniature radar mapping array is installed on the robot platform, and is preferably rectangular, H-shaped, polygonal, circular or their equivalent deformations such as elliptic, combined rectangular and circular, and arch-shaped. FIG. 2 shows a typical rectangular miniature radar mapping array, wherein the robot platforms are labeled as 1, the miniature radars are labeled as 2 and are in a rectangular arrangement, an integrated module of the miniature radar data acquisition module and the host computer is labeled as 3. Other equivalent transformations based on the rectangular miniature radar mapping array shall also be within the protection scope of the present invention. For example, FIG. 3 shows a staggered rectangular miniature radar mapping array, wherein the miniature radars are arranged in a rectangle, and a edge of the rectangle is not directly connected with other three edges of the rectangle. FIG. 4 shows a polygonal miniature radar mapping array, wherein the miniature radars are arranged in a polygon. FIG. 5 shows a typical H-shaped rectangular miniature radar mapping array, wherein the miniature radars are arranged in an H-shape. FIG. 6 shows a circular miniature radar mapping array, wherein the miniature radars are arranged in a circle. Obviously, other equivalent transformations based on the above miniature radar mapping arrays, such as the forward, backward, upward and downward parallel movement of the miniature radars in these arrays, and the combination of these arrays, shall also be within the protection scope of the present invention. FIG. 7 shows a combined rectangular and circular miniature radar mapping array, wherein the miniature radars are arranged in a combination of rectangle and circular arc. Here, other forms of arrays are not listed. The environmental sample data sampled by the miniature radar data acquisition module are transmitted to the navigation software of the host computer, the position, speed, attitude and other navigation information of the robot at the current moment are obtained by the navigation software and are transmitted to the mapping software of the host computer. A 360° 3D mapping model of the environment is constructed by the mapping software based on a miniature radar detection model and a miniature radar array model, which is a component unit for generating panoramic 3D maps of complex narrow space. An implementation process of the miniature radar array mapping system comprises steps of:
(1) Obtaining environmental sample data and environmental sample time labels by environmental information sampling of the miniature radar mapping array, and transmitting to the miniature radar data acquisition module, wherein:
the miniature radar mapping array is a rectangular miniature radar mapping array, the miniature radars are installed at upper, lower, left and right directions respectively (but not limited to these four directions);
for the miniature radar mapping array with navigation requirement at a certain direction, it is necessary to arrange multiple rows of miniature radars, wherein due to navigation requirement, two (but not limited to two) rows of miniature radars are arranged at a lower portion of the miniature radar mapping array, there are three (but not limited to three) miniature radars in each row; there are three (but not limited to three) rows of miniature radars at the left, right and upper directions respectively, there are two (but not limited to two) miniature radars in each row; the miniature radars in all directions are positioned to the body frame of the robot, and the front and back of the miniature radars with navigation requirement are corresponding to each other;
an elevation angle β and an azimuthal angle γ in the body frame are used to position the miniature radars, the elevation angle β is an angle between the orientation of the miniature radars and the XOY plane in the body frame, the azimuthal angle γ is an angle between the orientation of the miniature radars and the YOZ plane in the body frame;
there are twelve miniature radars in the miniature radar mapping array;
(2) Constructing a 360° 3D mapping model by the mapping software of the host computer based on a miniature radar detection model and a miniature radar array model, and transforming sampled information into an image matrix, wherein:
the miniature radar detection model is based on two parameters of the miniature radars, namely, a field angle α and a measuring distance d, a measuring area of the miniature radars is a circle with a radius of d tan(α/2), here, the measuring distance d is a distance from an object to a miniature radar antenna in a coverage area;
in the miniature radar array model, coordinates of the i^{th} miniature radar in the body frame are

$$[ \begin{matrix}{x}_{b , i}^{r} \\ {y}_{b , i}^{r} \\ {z}_{b , i}^{r}\end{matrix} ] ,$$

setting angles are (βᵢ,γᵢ), here, the subscript b indicates that in the body frame, the superscript γ indicates that the coordinate value is the coordinate of the i^{th} miniature radar, coordinates of the center point of the area measured by the i^{th} miniature radar are

$$[ \begin{matrix}{x}_{b , i} \\ {y}_{b , i} \\ {z}_{b , i}\end{matrix} ] = [ \begin{matrix}{x}_{b , i}^{r} \\ {y}_{b , i}^{r} \\ {z}_{b , i}^{r}\end{matrix} ] + {d}_{i} \cdot [ \begin{matrix}sin {β}_{i} cos {γ}_{i} \\ sin {β}_{i} sin {γ}_{i} \\ cos {β}_{i}\end{matrix} ] ;$$

coordinates

$$[ \begin{matrix}{X}_{b}^{r} \\ {Y}_{b}^{r} \\ {Z}_{b}^{r}\end{matrix} ]$$

of all miniature radars in the body frame are

$$[ \begin{matrix}{X}_{b}^{r} \\ {Y}_{b}^{r} \\ {Z}_{b}^{r}\end{matrix} ] = [ \begin{matrix}{x}_{b , 1}^{r} & {x}_{b , 2}^{r} & … & {x}_{b , n}^{r} \\ {y}_{b , 1}^{γ} & {y}_{b , 2}^{r} & … & {y}_{b , n}^{r} \\ {z}_{b , 1}^{r} & {z}_{b , 2}^{r} & … & {z}_{b , n}^{r}\end{matrix} ] ;$$

under the same sampling period, the environmental sample information obtained by environmental information sampling of the miniature radar mapping array is expressed as

$${Z}_{r} = [ \begin{matrix}{d}_{1} & 0 & … & 0 \\ 0 & {d}_{2} & … & 0 \\ ⋮ & ⋮ & ⋱ & ⋮ \\ 0 & 0 & … & {d}_{12}\end{matrix} ] ;$$

a measured value Z_{b} of environmental information sampling of the miniature radar mapping array in the body frame is expressed as

$${Z}_{b} = [ \begin{matrix}{X}_{b}^{r} \\ {Y}_{b}^{r} \\ {Z}_{b}^{r}\end{matrix} ] + A \cdot {Z}_{r} ,$$

here, A is a transformational matrix for transforming the environmental sample information in the body frame, and is expressed as

$$A = [ \begin{matrix}sin {β}_{1} cos {γ}_{1} & sin {β}_{2} cos {γ}_{2} & … & sin {β}_{n} cos {γ}_{n} \\ sin {β}_{1} sin {γ}_{1} & sin {β}_{2} sin {γ}_{2} & … & sin {β}_{n} sin {γ}_{n} \\ cos {β}_{1} & cos {β}_{2} & … & cos {β}_{n}\end{matrix} ] ,$$

and
(3) Building a 360° map of the scene, wherein:
according to the position p and velocity v of the robot in the navigation software, if the terrain features of the miniature radar mapping array are used to match the navigation, the forward motion velocity vₓ of the robot platform is obtained, the detection period of the miniature radar mapping array is T, the detection sample at time k is expressed as Dₖ=(d_{k,1}, d_{k,2}, d_{k,3});
the detection sample of the miniature radar mapping array obey the normal distribution, then the mean square error of the corresponding sample data before and after of the miniature radar mapping array obeys the chi-square distribution, which is expressed as

$${Δ}_{k , k + p} = \sqrt{\frac{{\sum }_{j = 1}^{3} {( {d}_{k + p , j} - {d}_{k , j} )}^{2}}{n}} \sim χ ( n ) ,$$

wherein, for ∀k and ∃p, Δ_{k,k+p}≤ε, here, ε is a confidence parameter, when the confidence parameter ε is small enough, it is able to guaranteed that Dₖ is similar to Dₖ₊ₚ, so the forward motion velocity of the robot platform is calculated by a formula of

$${v}_{x} = \frac{L}{pT} ,$$

here, L is a distance between miniature radar mapping arrays, the forward motion position pₓ is obtained by integrating the forward motion velocity;
the position p and the velocity v of the robot platform are sent to the navigation software for integrated navigation, coordinates of the centroid of the robot in the ground coordinate is expressed by calculation of the navigation software as

$$S = [ \begin{matrix}{x}_{e} \\ {y}_{e} \\ {z}_{e}\end{matrix} ] ;$$

when the environmental sample information obtained by the miniature radar mapping array is transformed into the ground coordinate system determined at the initial moment, it is required to perform the coordinate transformation according to the attitude of the robot, then the coordinate transformation matrix C is expressed as

$$C = [ \begin{matrix}cos ψcos θ & cos ψsin θsin ϕ - sin ψcos ϕ & cos ψsin θcos ϕ + sin ψsin ϕ \\ sin ψcos θ & sin ψsin θsin ϕ - cos ψcos ϕ & sin ψsin θcos ϕ - cos ψsin ϕ \\ - sin ϕ & cos θsin ϕ & cos θcos ϕ\end{matrix} ] ,$$

here, ψ is a yaw angle, θ is a pitch angle, ϕ is a roll angle; in order to rotate the coordinate matrix in the body frame to be parallel to the ground coordinate system, the measured value Z_{b} needs to be multiplied by the coordinate transformation matrix C to the left;
based on the superposition of the measured value Z_{b} of the miniature radar mapping array in the body frame and the coordinates of the centroid of the robot in the ground coordinate system in the same period, the coordinates of the environmental sample information of the miniature radar mapping array in the ground coordinate system at this moment are obtained, which are expressed as

$${Z}_{e} = [ \begin{matrix}{x}_{e} \\ {y}_{e} \\ {z}_{e}\end{matrix} ] \cdot I + C \cdot {Z}_{b} , \\ here , I = [ \begin{matrix}1 & 1 & … & 1\end{matrix} ] ,$$

the measured values of the environmental sampling are transformed to the ground coordinate system and the grids occupied in the three-dimensional space are marked to form a three-dimensional topographic map.

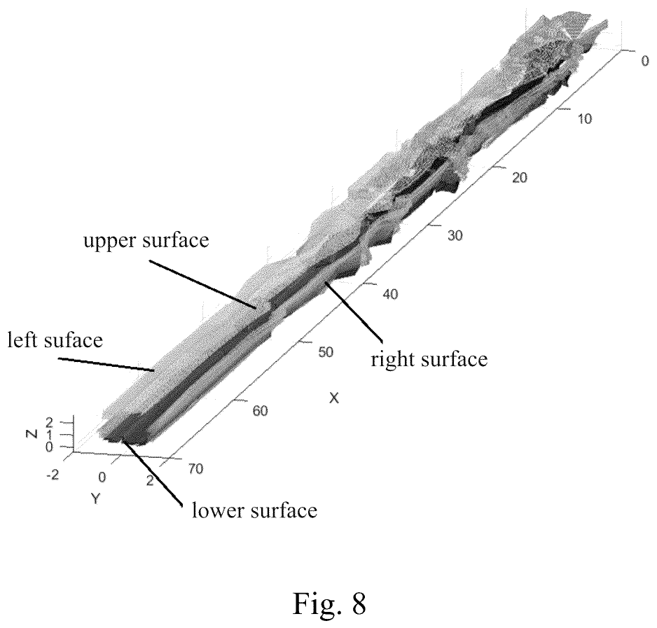

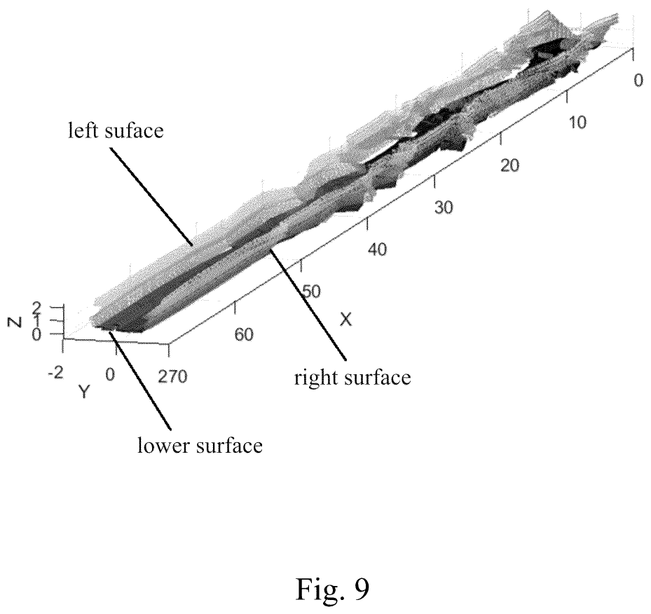

FIGS. 8 and 9 show the 360° three-dimensional terrain panorama map and the 360° three-dimensional terrain perspective map, respectively.

The above embodiments are only the better embodiments of the present invention and are not intended to limit the implementation scope of the present invention. Therefore, any quantitative and structural changes made in accordance with the process, principle, algorithm and miniature radar mapping array of the present invention shall fall within the protection scope of the present invention.

What is claimed is:

1. A miniature radar array mapping system in complex narrow space, comprising a miniature radar mapping array, a miniature radar data acquisition module, a host computer and a robot platform, wherein:
a software system of the host computer comprises navigation software and mapping software;
the robot platform is an air robot motion platform, a ground mobile robot motion platform, a land and air amphibious robot or underwater robot motion platform;
miniature radars of the miniature radar mapping array are laser radars, ultrasonic radars, millimeter wave radars or a combination of laser radars, ultrasonic radars and millimeter wave radars; and for underwater environments, active sonar probes are selected to form the miniature radar mapping array; environmental sample data are obtained by environmental information sampling of the miniature radar mapping array and then transmitted to the miniature radar data acquisition module;
the environmental sample data sampled by the miniature radar data acquisition module are transmitted to the navigation software of the host computer;
position, velocity and attitude information of a robot at a current moment are obtained by the navigation software and are transmitted to the mapping software;
a 360° 3D mapping model of environment is constructed by the mapping software based on a miniature radar detection model and a miniature radar array model, which is a component unit for generating panoramic 3D maps of the complex narrow space.

2. The miniature radar array mapping system according to claim 1, wherein the miniature radar mapping array is installed on the robot platform, the miniature radars detect the environmental sample information in a direction away from the robot; there are multiple rows of miniature radars in each direction; the miniature radar mapping array is rectangular, H-shaped, polygonal, or circular; or equivalent deformations of these forms, the forward, backward, upward and downward parallel movement of the miniature radars in these arrays; or a combination of these arrays, elliptic, a combination of a portion of rectangle and a portion of circle or arch, a circular or arc-shaped array formed by a portion of a circle or arch; the miniature radar mapping array comprises n miniature radars which are positioned to a body frame OXYZ of the robot, an installation angle of the miniature radars of the miniature radar mapping array comprises an elevation angle β and an azimuthal angle γ in the body frame OXYZ, wherein the elevation angle β is an angle between an orientation of the miniature radars and an XOY plane in the body frame, the azimuthal angle γ is an angle between an orientation of the miniature radars and a YOZ plane in the body frame.

3. The miniature radar array mapping system according to claim 1, wherein miniature radars of the miniature radar mapping array are configured to measure surrounding environmental information, and to synchronously or sequentially sample relative distance information between the robot and buildings, walls and objects in surrounding environment according to a preset frequency; the host computer is configured to obtain the environmental sample data of the miniature radars.

4. The miniature radar array mapping system according to claim 1, wherein the miniature radar detection model is based on two parameters of the miniature radars, a field angle α and a measuring distance d; beam of the miniature radars form a projection surface on a measured object, a shape of the projection surface is affected by a shape of the object, a coverage area of the beam is a circle with a radius of d tan(α/2), here, the measuring distance d is a distance from the object to a miniature radar antenna in the coverage area;
in the miniature radar array model, coordinates of the i^{th} miniature radar in the body frame are
$$[ \begin{matrix}{x}_{b , i}^{r} \\ {y}_{b , i}^{r} \\ {z}_{b , i}^{r}\end{matrix} ] ,$$
setting angles are (βᵢ,γᵢ), i∈{1, 2 . . . , n}, here, the subscript b indicates that in the body frame, the superscript γ indicates that the coordinate value is the coordinate of the i^{th} miniature radar, di is the distance, coordinates of a center point of a area measured by the i^{th} miniature radar indicate measured environmental information and are expressed as
$$[ \begin{matrix}{x}_{b , i} \\ {y}_{b , i} \\ {z}_{b , i}\end{matrix} ] = [ \begin{matrix}{x}_{b , i}^{r} \\ {y}_{b , i}^{r} \\ {z}_{b , i}^{r}\end{matrix} ] + {d}_{i} \cdot [ \begin{matrix}sin {β}_{i} cos {γ}_{i} \\ sin {β}_{i} sin {γ}_{i} \\ cos {β}_{i}\end{matrix} ] ; \\ [ \begin{matrix}{X}_{b}^{r} \\ {Y}_{b}^{r} \\ {Z}_{b}^{r}\end{matrix} ]$$
coordinates of all miniature radars in the body frame are
$$[ \begin{matrix}{X}_{b}^{r} \\ {Y}_{b}^{r} \\ {Z}_{b}^{r}\end{matrix} ] = [ \begin{matrix}{x}_{b , 1}^{r} & {x}_{b , 2}^{r} & … & {x}_{b , n}^{r} \\ {y}_{b , 1}^{r} & {y}_{b , 2}^{r} & … & {y}_{b , n}^{r} \\ {z}_{b , 1}^{r} & {z}_{b , 2}^{r} & … & {z}_{b , n}^{r}\end{matrix} ] ;$$
under a same sampling period, the environmental sample information obtained by environmental information sampling of the miniature radar mapping array is expressed as
$${Z}_{r} = [ \begin{matrix}{d}_{1} & 0 & … & 0 \\ 0 & {d}_{2} & … & 0 \\ ⋮ & ⋮ & ⋱ & ⋮ \\ 0 & 0 & … & {d}_{12}\end{matrix} ] ;$$
a measured value Z_{b} of environmental information sampling of the miniature radar mapping array in the body frame is expressed as
$${Z}_{b} = [ \begin{matrix}{X}_{b}^{r} \\ {Y}_{b}^{r} \\ {Z}_{b}^{r}\end{matrix} ] + A \cdot {Z}_{r} ,$$
here, A is a transformational matrix for transforming the environmental sample information in the body frame, and is expressed as
$$A = [ \begin{matrix}sin {β}_{1} cos {γ}_{1} & sin {β}_{2} cos {γ}_{2} & … & sin {β}_{n} cos {γ}_{n} \\ sin {β}_{1} sin {γ}_{1} & sin {β}_{2} sin {γ}_{2} & … & sin {β}_{n} sin {γ}_{n} \\ cos {β}_{1} & cos {β}_{2} & … & cos {β}_{n}\end{matrix} ] .$$

5. A miniature radar array mapping method in complex narrow space comprising:
transforming the environmental sample information obtained by the miniature radar mapping array into a ground coordinate system determined at an initial moment, wherein it is required to perform coordinate transformation according to the attitude of the robot, a coordinate transformation matrix C is expressed as
$$C = [ \begin{matrix}cos ψcos θ & cos ψsin θsin ϕ - sin ψcos ϕ & cos ψsin θcos ϕ + sin ψsin ϕ \\ sin ψcos θ & sin ψsin θsin ϕ - cos ψcos ϕ & sin ψsin θcos ϕ - cos ψsin ϕ \\ - sin ϕ & cos θsin ϕ & cos θcos ϕ\end{matrix} ] ,$$
here, ψ is a yaw angle, θ is a pitch angle, ϕ is a roll angle; in order to rotate the coordinate matrix in the body frame to be parallel to the ground coordinate system, the measured value Z_{b} needs to be multiplied by the coordinate transformation matrix C to the left;
coordinates S of a centroid of the robot in the ground coordinate system is obtained by the navigation software, and is expressed as
$$S = [ \begin{matrix}{x}_{e} \\ {y}_{e} \\ {z}_{e}\end{matrix} ] ;$$
based on a superposition of the measured value Z_{b} of the miniature radar mapping array in the body frame and the coordinates
$$[ \begin{matrix}{x}_{e} \\ {y}_{e} \\ {z}_{e}\end{matrix} ]$$
of the centroid of the robot in the ground coordinate system in the same period, coordinates of the environmental sample information of the miniature radar mapping array in the ground coordinate system at this moment are obtained, which are expressed as
$${Z}_{e} = [ \begin{matrix}{x}_{e} \\ {y}_{e} \\ {z}_{e}\end{matrix} ] \cdot I + C \cdot {Z}_{b} , \\ here , I = [ \begin{matrix}1 & 1 & … & 1\end{matrix} ] ;$$
the measured values of the environmental sampling are transformed to the ground coordinate system, and the grids occupied in the three-dimensional space are marked to form a three-dimensional topographic map.
